(19) United States
(12) Patent Application Publication
(10) Pub. No.: US 2016/0132645 A1
(43) Pub. Date: May 12, 2016

(54) SYSTEM AND ARCHITECTURE FOR PROVIDING SHARED PATIENT DATA NOTIFICATIONS

(71) Applicant: QSI Management, LLC, Irvine, CA (US)

(72) Inventors: Yvan G. Charpentier, Rockville, MD (US); Muhammad H. Chebli, Monmouth Junction, NJ (US); Gary Teichrow, Aliso Viejo, CA (US)

(21) Appl. No.: 14/935,131

(22) Filed: Nov. 6, 2015

Related U.S. Application Data
(60) Provisional application No. 62/076,738, filed on Nov. 7, 2014.

(51) Int. Cl. G06F 19/00

(52) U.S. Cl. CPC G06F 19/322

(57) ABSTRACT

A system is disclosed that personalizes the display of a patient's electronic healthcare record (EHR) for a user to enable the user to readily identify those data items that have been added since the user last accessed the EHR. The system maintains records of when particular users access particular EHRs, and uses these records to generate the personalized views.

### BACKGROUND

An electronic health record (EHR) is a digital version of a patient's paper chart. EHRs provide real-time, patient-centered records that make information available instantly and securely to authorized users. While an EHR contains the medical and treatment histories of patients, an EHR system can go beyond standard clinical data collected in a provider's office and can be inclusive of a broader view of a patient's care. An EHR can contain a patient's medical history, diagnoses, medications, treatment plans, immunization dates, allergies, radiology images, and laboratory and test results. An EHR system can allow access to evidence-based tools that healthcare providers can use to make decisions about a patient's care. An EHR can help automate and streamline provider workflow. One feature of an EHR is that health information can be created and managed by authorized providers in a digital format capable of being shared with other providers across more than one healthcare organization. EHRs can be designed to share information with other third party systems (e.g., healthcare providers and organizations)—such as laboratories, specialists, medical imaging facilities, pharmacies, emergency facilities, and school and workplace clinics—so they may contain information from all clinicians involved in a patient's care.

### BRIEF DESCRIPTION OF THE DRAWINGS

FIG. 1 illustrates an example user interface providing a notification view of new or updated patient information available since a certain date, such as a last date of access by a viewing user, as used in one embodiment of an electronic health record system.

FIG. 2 illustrates an example user interface to enable a user to perform a patient data record search, as used in one embodiment of an electronic health record system.

FIG. 3 illustrates an example user interface providing a search results listing of matching patient data records, as used in one embodiment of an electronic health record system.

FIG. 4 illustrates an example user interface providing a patient data record view, including a user-selectable option to view updates to shared clinical patient information, as used in one embodiment of an electronic health record system.

FIG. 5 illustrates an example user interface providing a notification view of new or updated patient information available since a certain date, such as date of inception of the patient information, as used in one embodiment of an electronic health record system.

FIG. 6 illustrates an example user interface providing a shared patient data view, including a user-selectable option to download shared clinical patient information, as used in one embodiment of an electronic health record system.

FIG. 7 illustrates an example user interface providing a shared patient data view, including a user-selectable option to filter shared clinical patient information by source of origin, as used in one embodiment of an electronic health record system.

FIG. 8 illustrates an example user interface providing a download patient record option menu, including a user-selectable option to select a format, data range, and/or source of origin associated with the shared clinical patient information, as used in one embodiment of an electronic health record system.

FIG. 9 illustrates an example user interface providing a patient data record reconciliation view, as used in one embodiment of an electronic health record system.

FIG. 10 is a flowchart for one embodiment of an example process for providing a notification summary of new and/or updated patient information since a date of last access or date of inception, as used in one embodiment of the EHR system of FIG. 11

FIG. 11 is a block diagram of an implementation of an illustrative EHR system.

### DETAILED DESCRIPTION OF SPECIFIC EMBODIMENTS

### Overview

One challenge faced by EHR systems is effective management and timely presentation of new and/or updated health information for patients. With an ever-increasing amount of electronic patient clinical data being collected and available, clinicians may experience “information overload” as they review patient health records. While having a detailed and comprehensive view and history for a patient can be vital and potentially life-saving, in some instances clinicians may benefit from quickly being able to discern and view what information is most recent. For example, a clinician may be particularly interested in new or updated patient clinical data which may have an impact with regards to an ongoing treatment or evolving diagnosis. With limited time available in which to review a patient's health record to identify such new or updated information since the last time the health record was accessed or reviewed, the clinician may benefit greatly from having such information readily available or presented for easier review, while avoiding having information previously reviewed by the clinician repeatedly presented.

The systems, methods, and user interfaces described herein provide notifications to the clinician of the availability, type, and status of data available in, or sourced by, third-party systems for a given patient. The system can provide a proactive indication that new clinical data has been created for the patient and is newly available since the last time the patient's EHR was accessed by the logged-in user. Additionally, the system can, in some embodiments, support the instantaneous retrieval and clinical reconciliation of newly available data.

A system configured to provide the features described herein may include several components. One component may comprise, for example, an EHR software application (e.g., web-based, mobile, stand-alone, or other implementation) which provides user interfaces for creating and documenting patient clinical information (e.g., to facilitate use and management of patient EHRs) that are viewable by a user on a client computing system. Another component may include a clinical data repository (CDR) which collects, organizes, and aggregates clinical data (e.g., EHRs for one or more patients) from many different sources, including different EHR applications as well as third party data sources, in an electronic data store. These sources may correspond to doctors (e.g., a patient's PCP), hospitals, labs, pharmacies, and/or the like. Each of these sources may interact with and manage different aspects of a patient's health. By aggregating clinical data from these various sources, the CDR can provide a more complete picture of the patient's health and medical history. The clinical data aggregated by the CDR may be viewed and queried (e.g., via the EHR software application and associated user interfaces). For example, a doctor may use an EHR software application to enter patient information (e.g., patient checkup information) to be stored by the CDR, while also being able to access information relating to the patient entered into the CDR by other sources (e.g., prescription information from a pharmacy, test results information from a lab, and/or the like).

A unique patient identifier may be used by the EHR application and the CDR to provide a standard way to search, retrieve, and manage data between the EHR application and the CDR, as well as from third-party systems and/or data sources. The patient identifier may enable healthcare applications and healthcare enterprises to find, exchange, and reference entity data while maintaining the data's context and associations, allowing patient matching across the various data sources to occur seamlessly across the different applications and enterprises.

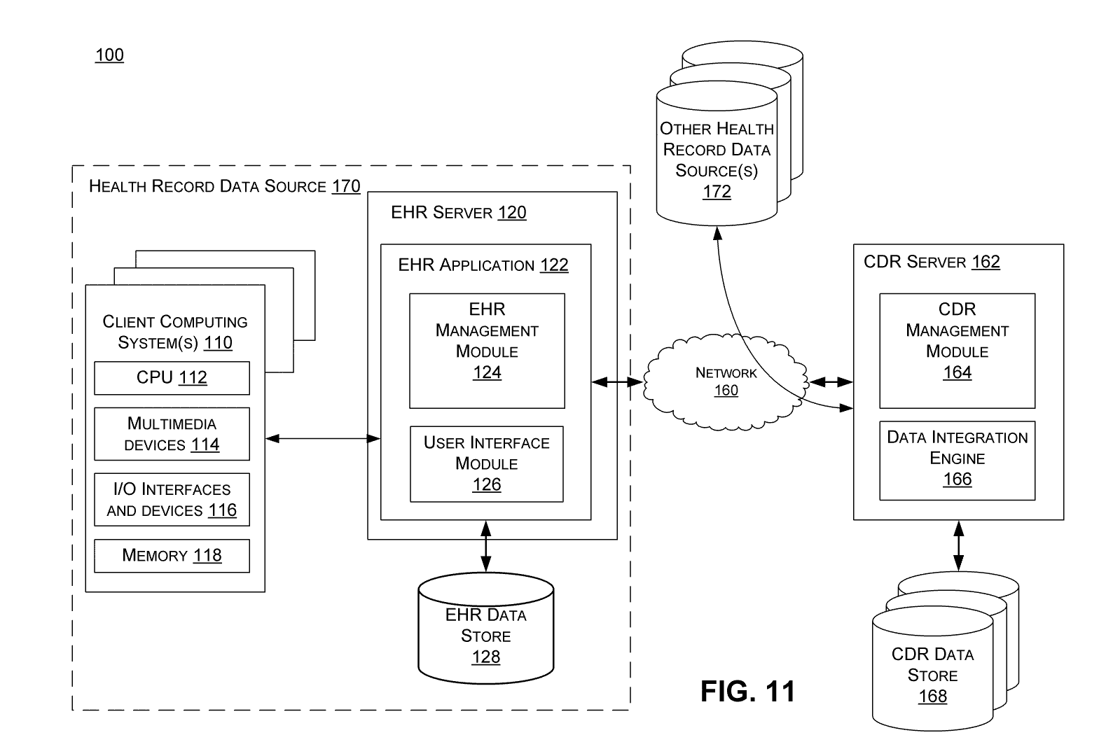

The types of clinical data that can be stored in the CDR may include, for example, full patient demographics and clinical observations, such as a patient's medical history, diagnoses, medications, treatment plans, immunization dates, allergies, radiology images, and laboratory and test results. For example, a patient's doctor may use the EHR software application to enter clinical information relating to the patient, as well as retrieve and view clinical information from the CDR for the patient entered by other healthcare entities, such as a lab, a pharmacy, and/or the like. A data integration engine can be used which supports the variety of data types and transports used in the system. An example system 100 configured to provide the features described in this disclosure is illustrated and described in more detail herein with reference to FIG. 11.

Generally described, the CDR may be configured to receive or access, from one or more third party entities (e.g., healthcare providers and/or organizations), clinical data for a plurality of patients to be collected, aggregated, and shared among the participating entities. Participating entitles may have previously connected to the CDR, enrolled in a sharing service or agreement, or otherwise completed a process by which they can indicate how and with which entities they wish to share clinical data.

In response to several types of events, such as new patient creation, existing patient update, and encounter creation, the EHR application may send patient information to the CDR server. For example, the EHR application may implement interface software, such as the NextGen Rosetta interface, to collect and record patient information and craft a message based on the collected information. In some embodiments, the message comprises an Admission, Discharge, Transfer (ADT) message (e.g., ADT_A28, A31, A04, or A08), and may contain a patient identifier (e.g., the EHR local identifier of the patient).

Upon successful transmission of the message from the EHR application to the CDR server, the CDR server extracts the information, allowing it to link patient information received from different sources, or create a new patient record if none is found.

In some embodiments, the EHR application may further collect and record clinical information, and craft the collected clinical information into a Medical Document Management message (e.g., a HL7 MDM message) to be transmitted to the CDR server. The MDM message may contain an embedded Continuity of Care Document (CCD) containing the collected clinical information. When received, the CDR server may use the demographical information within the MDM message to locate the patient record. In some embodiments (e.g., where the CDR server previously received an ADT message from the EHR system), the CDR server uses the local EHR identifier to lookup the patient record. The CDR extracts the clinical information and integrates it with the patient's data record, keeping track of it provenance. In some embodiments, the EHR application may communicate with the CDR server using a single type of message (e.g., using an MDM message but not an ADT message).

After a patient visit to a healthcare provider is complete, and according to the practice policies, the encounter will be closed (e.g., either through manual locking or through a time lock mechanism). This event can signal a background process of the EHR application to collect the encounter information (e.g., clinical documentation data) and send it to the CDR server for processing and storage. The CDR server may, via a data integration engine, merge the received encounter information with an existing patient data record or create a new patient data record. At this point, the encounter information may become available to other entities (e.g., other healthcare entities) that are able access the CDR server and query for information relating to the patient.

Once the encounter information is received, the CDR server may (1) invoke a patient identify matching process to identify the patient, (2) process and/or parse the clinical information, and (3) insert this information into its database. At this point the information may be available to the CDR server to enable querying for information about the patient by various EHR applications associated with various healthcare entities or third party entities. All information inserted in the CDR (e.g., the clinical data repository 170) may be linked to the source of the data (using a practice identifier). This linkage may provide several benefits. For example, the linkage information allows users to know the origin of the data (e.g., a hospital, a lab, etc.). Second, the linkage information enables filtering of the data sourced by an EHR system at a third party entity, since this data would already be known by the third party entity and thus may not be desirable to be included in the notification logic.

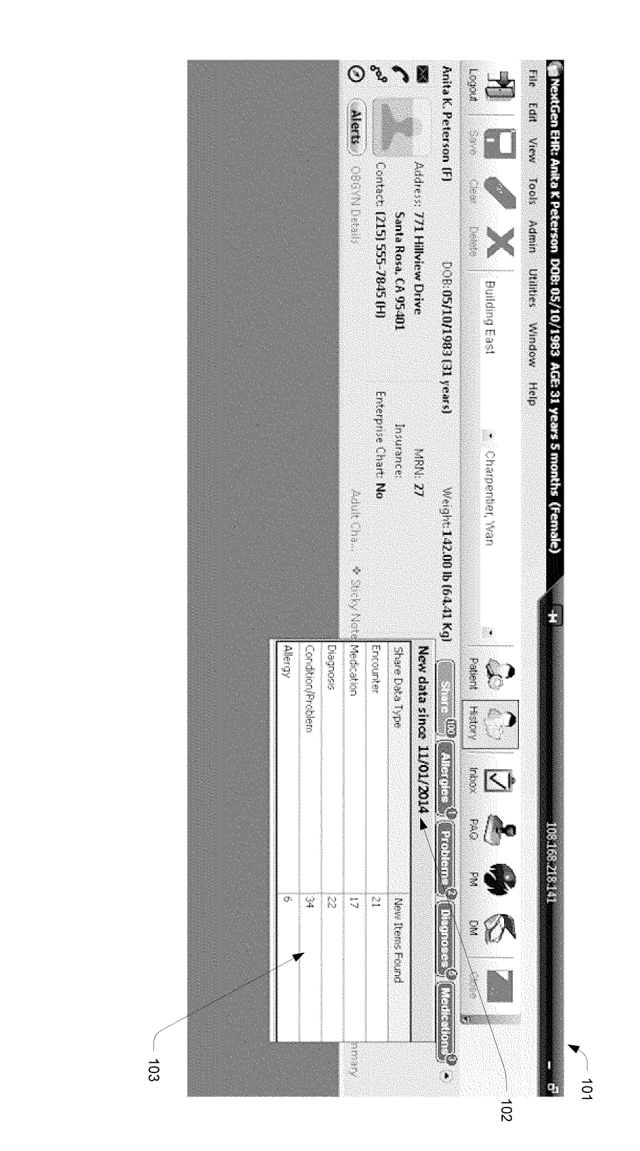

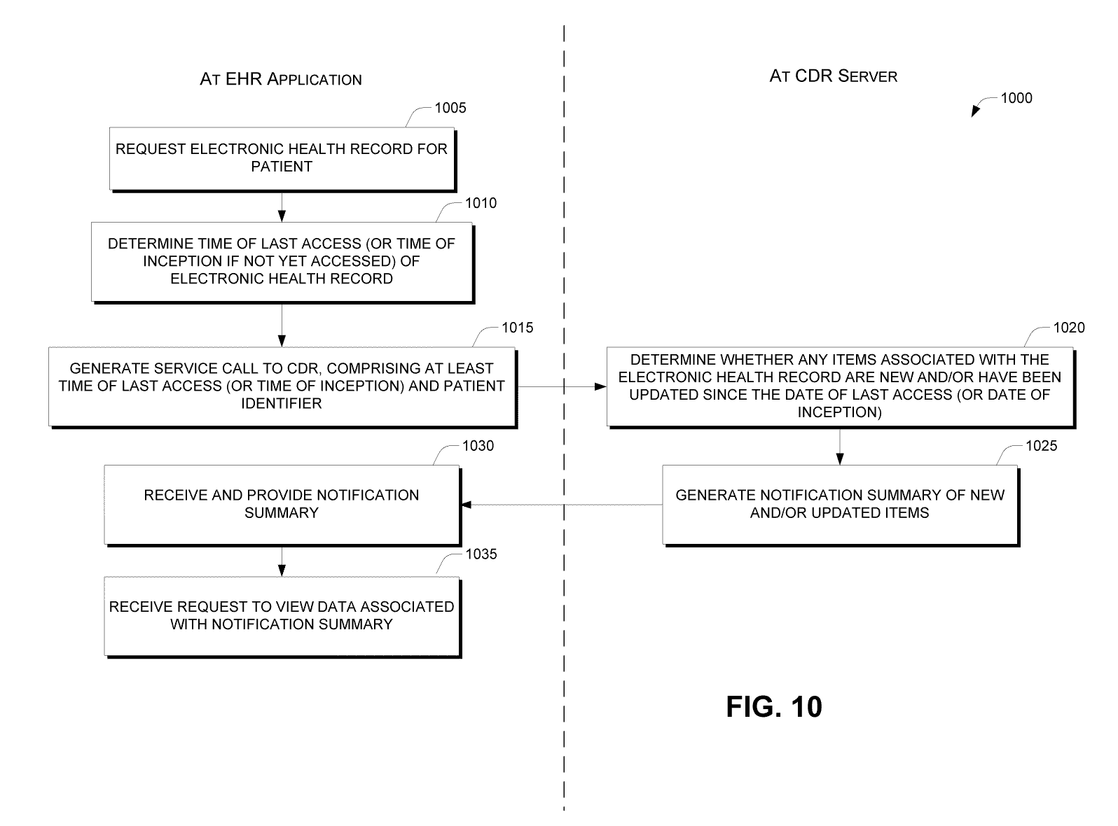

An example use case scenario describing how new and/or updated patient information notifications may be generated and provided according to one embodiment is presented and described herein with reference to the accompanying user interfaces shown in FIGS. 1-9 and in the flowchart illustrated in FIG. 10.

Embodiments of the disclosure will now be described with reference to the accompanying figures. The terminology used in the description presented herein is not intended to be interpreted in any limited or restrictive manner, simply because it is being utilized in conjunction with a detailed description of certain specific embodiments of the disclosure. Furthermore, embodiments of the disclosure may include several novel features, no single one of which is solely responsible for its desirable attributes or which is essential to practicing the embodiments of the disclosure herein described.

For purposes of this disclosure, certain aspects, advantages, and novel features of various embodiments are described herein. It is to be understood that not necessarily all such advantages may be achieved in accordance with any particular embodiment of the invention. Thus, for example, those skilled in the art will recognize that one embodiment may be carried out in a manner that achieves one advantage or group of advantages as taught herein without necessarily achieving other advantages as may be taught or suggested herein.

The example user interfaces illustrated in FIGS. 1-9, the example process shown in FIG. 10, and the system 100 of FIG. 11 may together illustrate one embodiment of the system. Other embodiments of the system may implement any of the example user interfaces illustrated in FIGS. 1-9, the example process shown in FIG. 10, and the system 100 of FIG. 11 in any combination thereof.

### Example User Interfaces

FIGS. 1-9 illustrate sample user interfaces that may be generated by or used with the system, such as the system 100 of FIG. 11. In various embodiments, each of the user interfaces shown in FIGS. 1-9 may be generated by an EHR application 122. In various embodiments, the user interfaces may be presented as a web page (e.g., via a web browser application), as a mobile application display, as a stand-alone application display, as an email message, as a text message (for example, a short message service (SMS) or a multimedia messaging service (MMS) message) or by other communication means. In other embodiments, analogous interfaces may be presented using audio or other forms of communication. In certain embodiments, each of the sample user interfaces described herein may also be displayed on any suitable computing device, such as a personal computer, desktop, laptop, cell/smart phone, tablet, or portable computing device.

The user interfaces described herein include examples of only certain features that the system may provide. Additional features may be provided, and they may be provided using various different user interfaces and software code. Depending on the embodiment, the user interfaces and functionality described with reference to FIGS. 1-9 may be provided by an EHR application executing on a client computing system 110, by an EHR application 122 located remotely (e.g., on an EHR server 120) that is in communication with the client computing system 110 via one or more networks, and/or some combination of EHR software executing on the client computing system and the remote system. In other embodiments, analogous interfaces may be presented using audio or other forms of communication. In an embodiment, the interfaces shown in FIGS. 1-9 are configured to be interactive and respond to various user interactions. Such user interactions may include clicks with a mouse, typing with a keyboard, touches, and/or gestures on a touch screen, voice commands, physical gestures made within a proximity of a user interface, and/or the like.

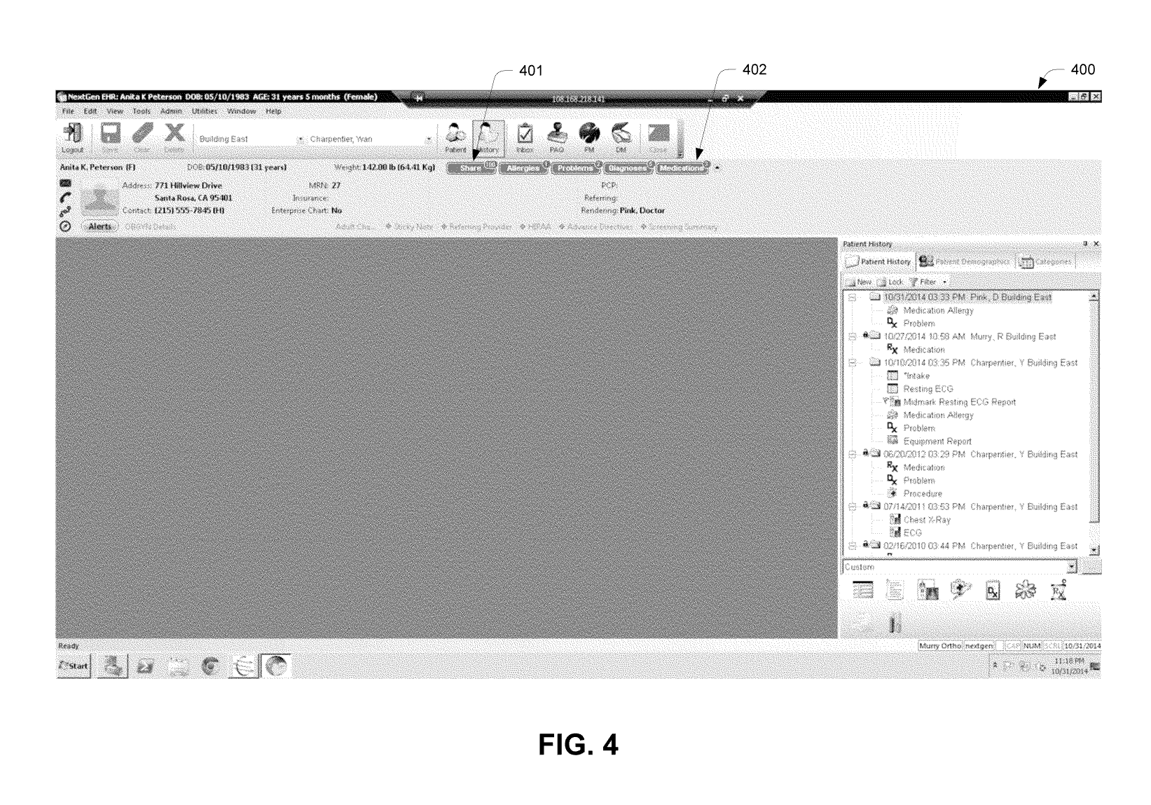

FIG. 1 illustrates an example user interface 101 providing a notification view of new or updated patient information available since a certain time, such as a last time of access by a viewing user, as used in one embodiment of the system. The notification view may be presented in association with a patient health record view, such as the one shown in FIG. 4, which displays various clinical information for a patient. In some embodiments, times (e.g., time of access) are recorded as dates at 102. Alternatively, times can be recorded at a more granular level (e.g., by the hour, minute, or second). In some embodiments, the notification view comprises a notification summary 103 displaying different categories associated with the new or updated patient information, and a number of items of new or updated patient information associated with each category.

In some embodiments, when a user views a patient record via the EHR application 122, the EHR application 122 may attempt to automatically connect to the CDR server 162 to access and retrieve new or updated patient information. Alternatively, the user may manually choose to have the EHR application access the CDR server 162 (e.g., by selecting a button or other user interface element in the EHR application).

The notification view shown in FIG. 1 may be presented, for example, as a popover menu or similar type of user interface display area which may be displayed in response to user selection of the “Share” button. The notification view may also include a numeric indicator appearing on or adjacent to the “Share” button, indicating how many new or updated items are available for viewing in the patient health record. The notification view popover display may provide a list of types of items (such as patient data items shared among various participating healthcare providers) and the respective number of new items found for each type of item. For example, item types may include encounters (e.g., patient visits at various participating healthcare providers), medications (e.g., prescribed by various participating healthcare providers), diagnoses (e.g., as made by various participating healthcare providers), conditions/problems (e.g., as determined by various participating healthcare providers), allergies (e.g., as determined by various participating healthcare providers), and other types of patient information not shown (e.g., new medical images which may be available, updates to patient contact information, etc.).

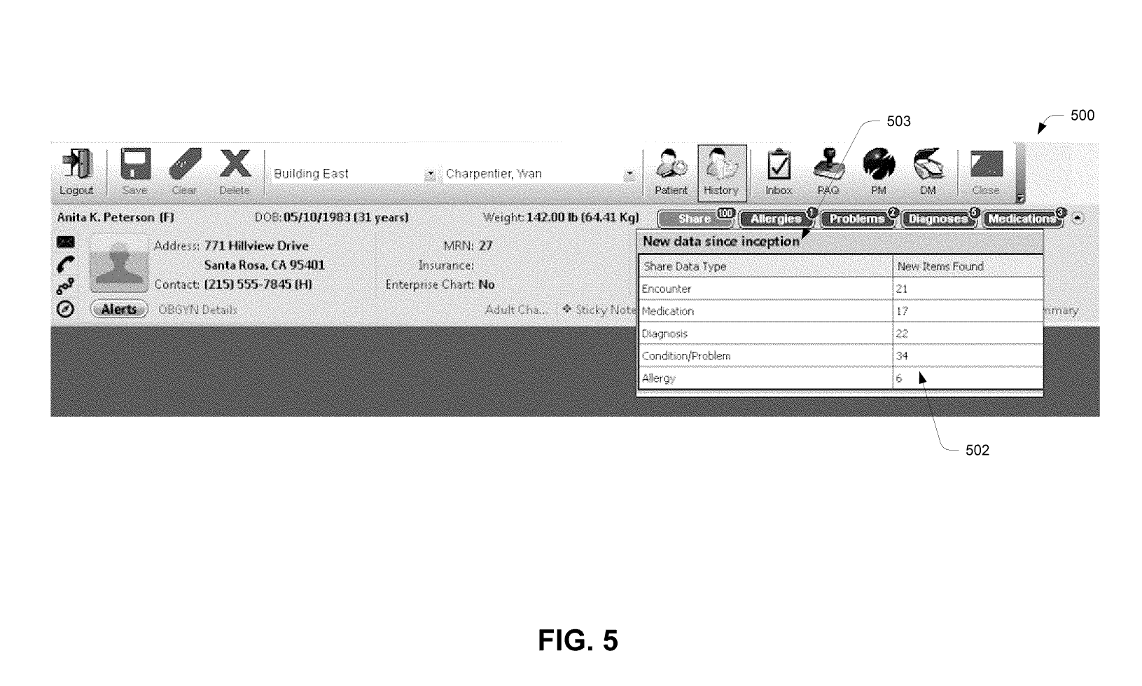

The notification view popover display may also include an indicator that the items included in the notification view are new or updated since a particular time. In some embodiments, the time may be the last date of access of the CDR by the viewing user. In some embodiments, such as the example shown in FIG. 5, the time may be the time of inception for the patient information (e.g., in instances where the patient information at the CDR may not have been accessed yet). The associated list of items or types of items may then only include those items which are new or updated since the time indicated, such that the viewing user can quickly assess whether and how much new patient information may be available.

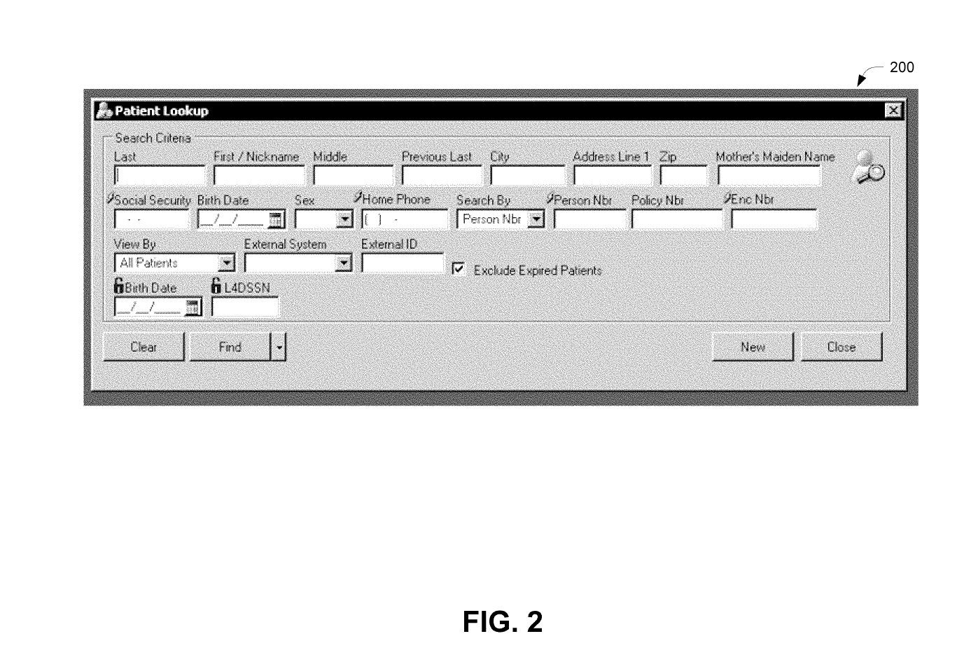

FIG. 2 illustrates an example user interface 200 to enable a user to perform a patient data record search, as used in one embodiment of the system. The patient data record search may enable the user to perform a patient lookup by providing values for one or more search fields, including for example: last name, first name, nickname, previous last name, address, city, zip code, mother's maiden name, social security number, birthdate, sex, home phone number, person number or identifier, policy number, and other identifiers. The patient lookup may include options to list or sort search results by certain types, by data source origin (e.g., external systems such as other participating healthcare provider systems), external identifier, birthdate, last 4 of SSN, and so on. Once a user has provided search criteria and specified sorting conditions, the user can press the “Find” button to search for matching patient records. In response, the EHR application may process the search request according to the criteria specified and generate and display the user interface 300 as described below.

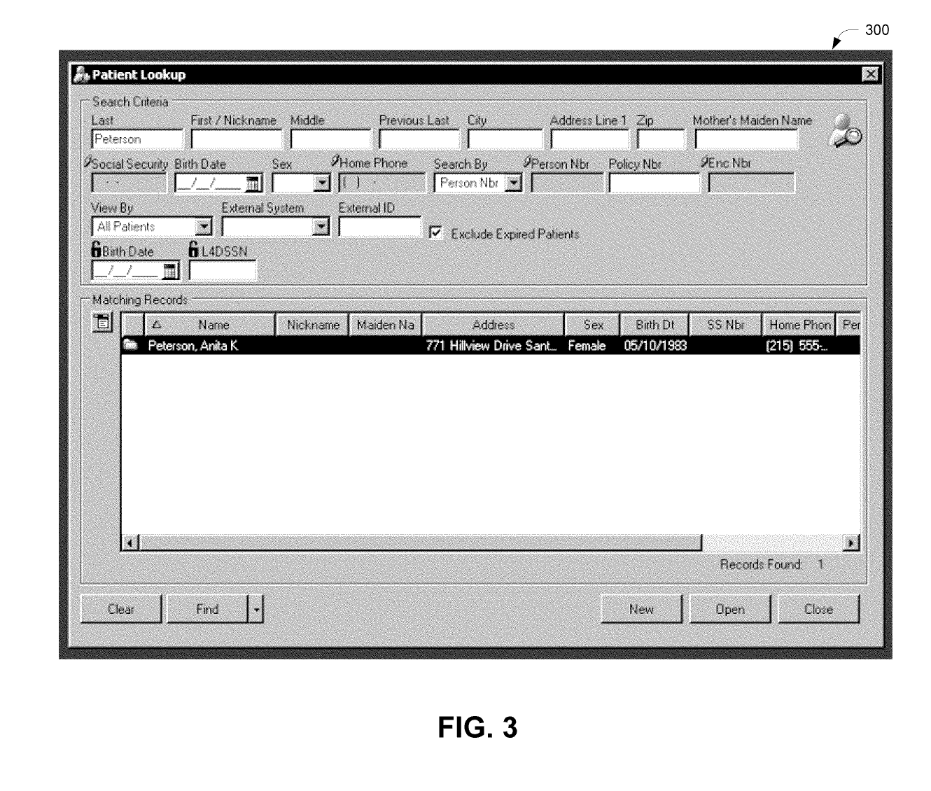

FIG. 3 illustrates an example user interface 300 providing a search results listing of matching patient data records, as used in one embodiment of the system. As illustrated in user interface 300, the search results listing may appear appended to the bottom of the patient search and lookup user interface 200 under a section labeled “Matching Results.” The list of matching results may include at least some basic information about each respective matching patient, such as name, nickname, maiden name, address, sex, birthdate, SSN, home phone, and so on. More or less data fields may be included in the display. The user can select one of the patients from the list of results, for example by double-clicking on the line item corresponding to the patient. In response, the EHR application may process the request generate and display the user interface 400 as described below.

FIG. 4 illustrates an example user interface 400 providing a patient data record view, including a user-selectable option to view updates to shared clinical patient information, as used in one embodiment of the system. The patient data record view may present various patient information retrieved from the CDR server. In some embodiments, when the patient record is accessed or opened, a web service call may be triggered by the EHR application 122 to the CDR server 162, causing the CDR server 162 to check for and retrieve new or updated data from the CDR repository 168 relevant to the patient. The web service call may include the patient unique identifier, the EHR user id, the practice identifier, and the time of last access. The time of last access might include a date and timestamp and indicate the date and/or time that the particular user last accessed the particular patient's health record via the CDR server. This web service call can be transmitted to the CDR server, for example through a secure VPN tunnel. Upon reception, the CDR server uses the patient identifier along with the practice identifier to identify the patient. Using the time information, the CDR server 162 can return the clinical type and number of new elements not contributed by the EHR application 122 to client computing system 110 (e.g., elements which are new to the particular healthcare provider's system).

Among other things, the patient data record view may display basic patient information (e.g., name, date of birth, weight, contact information); a patient history panel including various items in the patient's medical history (e.g., medications prescribed, allergies identified, problems noted, procedures performed, etc.); and one or more item summary buttons and associated numeric indicators which may be of interest to the clinician. The summary indicators may include, for example, a “Share” button 401 and numeric indicator of how many new or updated items retrieved from the CDR server may be available for viewing in the patient's record, for example since the last access time by the requesting user or since inception of the patient information (e.g., if it has not yet been accessed). The numeric indicator may be generated by the CDR server in response to the request to access the patient health record, for example as described with reference to the process 1000 of FIG. 10, or by the EHR application in response to received data from the CDR server. The user can hover a mouse pointer over the “Share” button to view a notification summary, as illustrated in the user interface 101 or the user interface 500 as described herein. For example, the notification summary may display a plurality of different categories associated with the new or updated items (e.g., encounters, medications, diagnoses, conditions/problems, allergies, and/or the like) and a number of new or updated items associated with each category. In addition, the user can elect to view the shared items in more detail (e.g., by double-clicking on the “Share” button). In response, the CDR may receive and process the request to generate and display the user interface 600 as described below.

The summary indicators may also include other buttons 402 corresponding to categories of patient data. As shown in FIG. 4, these may include an “Allergies” button and numeric indicator of how many allergies with which the patient may be diagnosed; a “Problems” button and numeric indicator of how many problems or complications are associated with the patient; a “Diagnoses” button and numeric indicator of how many diagnoses are associated with the patient; and a “Medications” button and numeric indicator of how many medications are prescribed to the patient. Selection of each of these respective buttons may trigger the EHR application to update the patient data record view to display the respective selected patient information corresponding to the selected category in the main panel display area in the user interface 400. In some embodiments, buttons 402 are associated with data items recorded for the patient at the EHR application, while the “Share” button 401 is associated with new or updated data items received by the EHR application from the CDR server.

FIG. 5 illustrates an example user interface 500 providing a notification view 502 of new or updated patient information available since a certain date, such as date of inception of the patient information 503, according to one embodiment. The notification view shown in user interface 500 is similar to the one illustrated and described with reference to FIG. 1 above, except that the particular date indicates that the data is new since inception instead of since a specific time. In some embodiments, the time of inception may also be provided. This indicator may be displayed, for example, when the data items in the notification view have not yet been accessed by the requesting user, but are otherwise new as of a certain inception or creation date (e.g., a time on which the patient data was first made available to the CDR server and/or stored in the CDR repository 168).

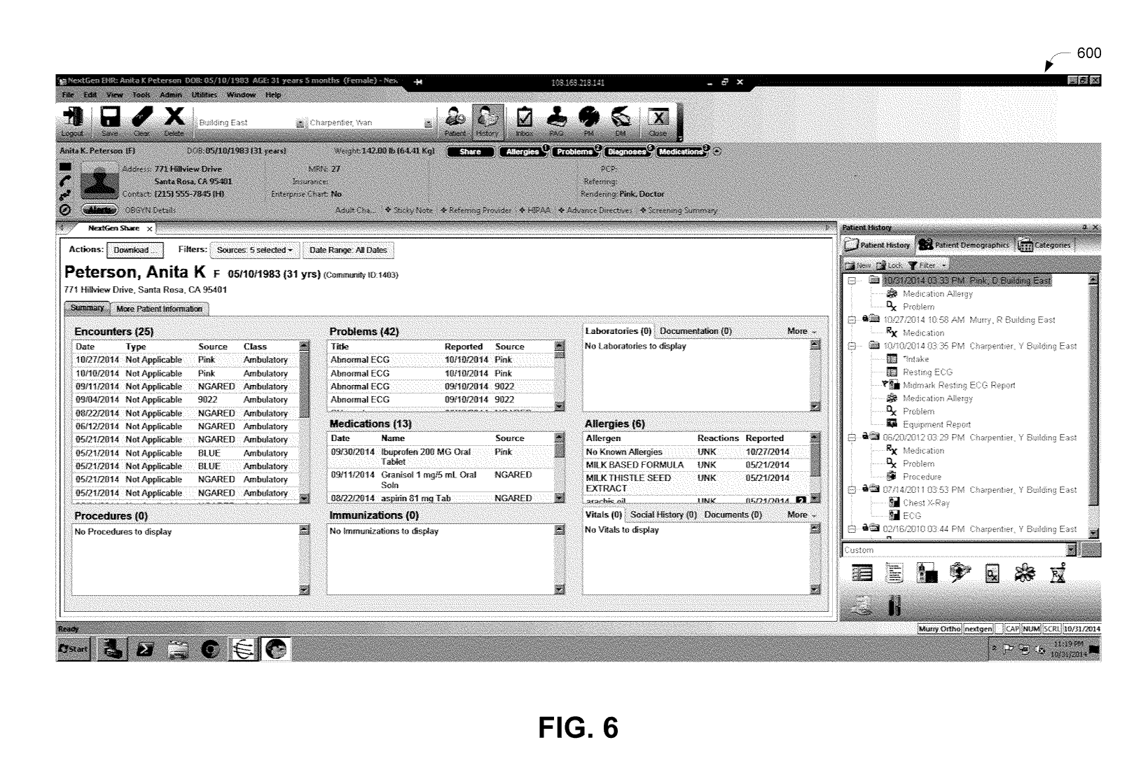

FIG. 6 illustrates an example user interface 600 providing a shared patient data view, including a user-selectable option to download shared clinical patient information, according to one embodiment. When the user selects the “Share” button, the client computing system 110 (e.g., through EHR application 1022) sends a request to the CDR server 162 to create a URL granting access to this patient's record. The call can include a patient ID (to view), a practice ID (practice OID), and a user ID (the user logged in the EHR application). In some embodiments, the URL is an expiring URL. For example, the response from the CDR server may include a secure URL containing a token to control the length of time the access is granted. Additionally, once the Share button is selected, the Share notification may be removed and the “last viewed time” set to a current time.

The shared patient data view may present various items in the patient's health record that have been collected and aggregated from multiple various participating healthcare providers at the CDR server. Items may be organized according to item types (e.g., encounters, procedures, problems, medications, immunizations, allergies, etc.). In some embodiments, items in the shared patient data view may be highlighted or otherwise include a visual marker to indicate those items which are new or have been updated since the last access date by the user or since the date of inception. The user interface 600 may also provide a “Download” button which the user may select in order to download the patient information to a local EHR database or repository (e.g., a memory 118 associated with client computing system 110, or an EHR data store 128 associated with EHR server 120). In response to selection of the Download option, the EHR application may process the request and generate and display the user interface 800 as described below.

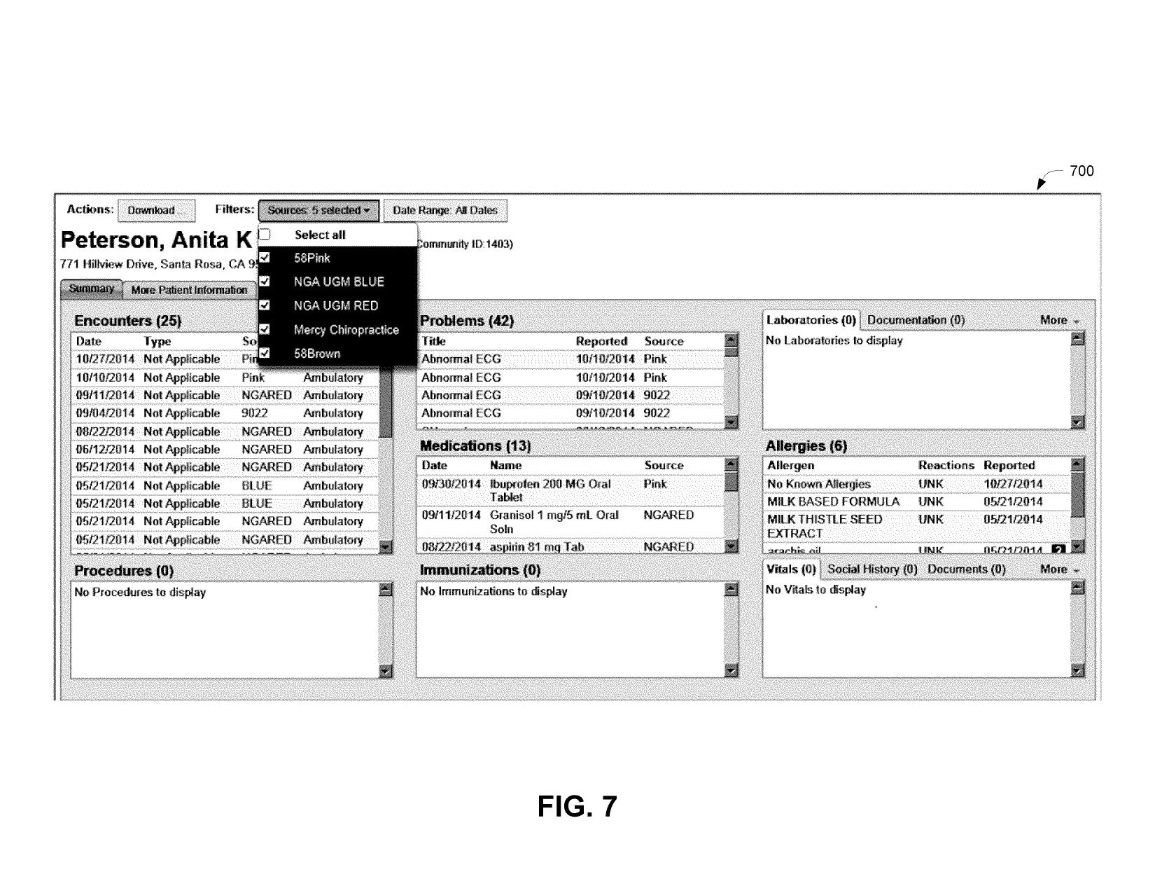

FIG. 7 illustrates an example user interface 700 providing a shared patient data view, including a user-selectable option to filter shared clinical patient information by source of origin, according to one embodiment of the system. The user interface 700 may present filter options in order to filter the data being displayed, for example by source or by a particular date range. In one embodiment, a filter may be provided to display only those items which are new or have been updated since the last access date or since the date of inception.

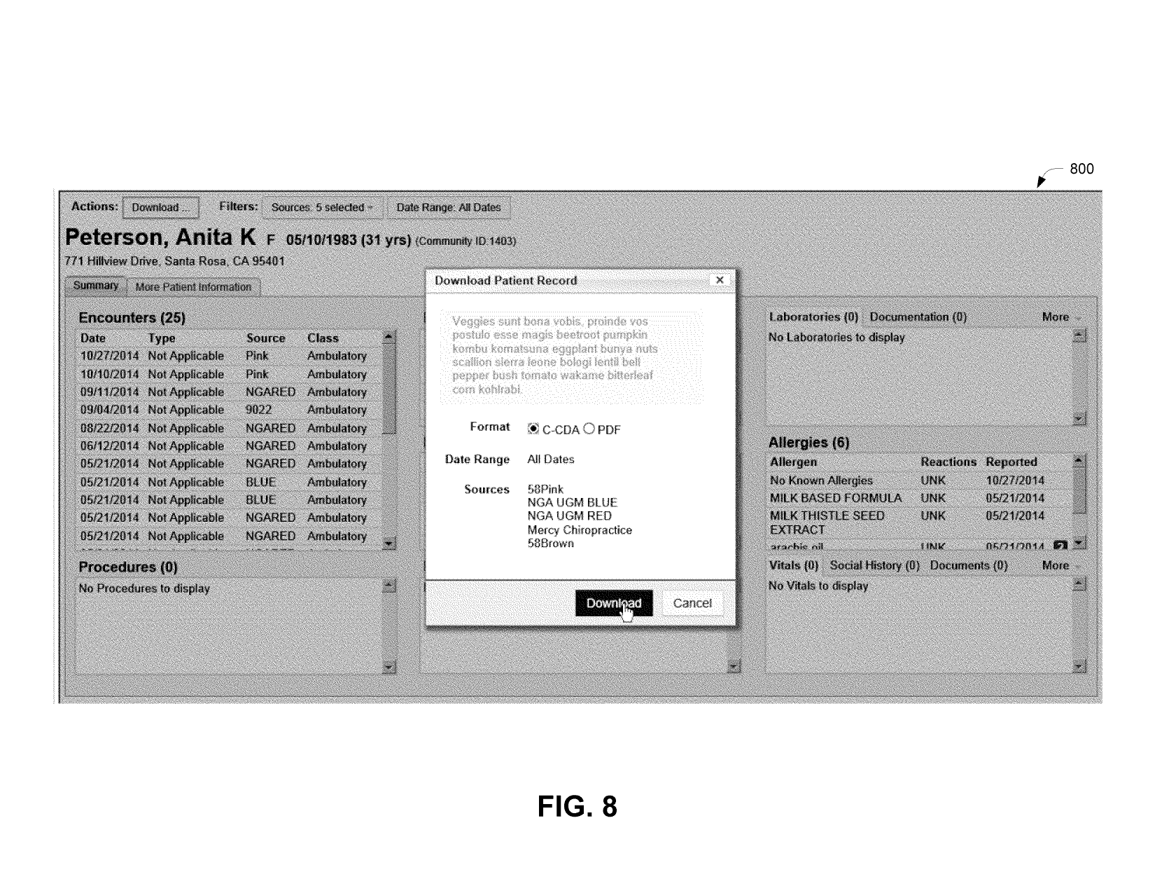

FIG. 8 illustrates an example user interface 800 providing a download patient record option menu, including a user-selectable option to select a format, data range, and/or source of origin associated with the shared clinical patient information, in one embodiment of the system. The download patient record option menu enables the user to download shared patient data (e.g., all shared patient data, only new or updated shared patient data, or shared patient data according to the filter criteria) to a local EHR database or to a client computing system 110. In this way healthcare providers can quickly view updates to shared patient data and download relevant information to their local EHR systems and repositories in order to maintain a more comprehensive view of the patient's health record. In one embodiment, in response to user selection of the Download option shown in user interface 800, the EHR application may process the request and generate and display the user interface 900 as described below.

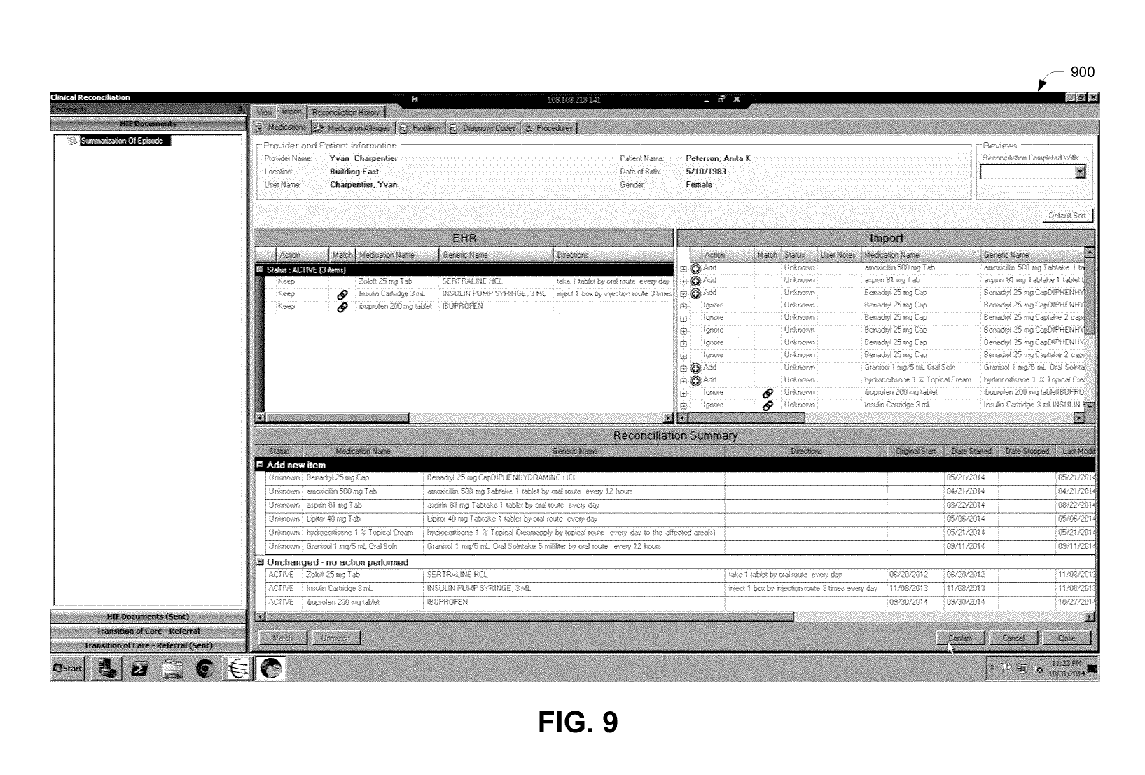

FIG. 9 illustrates an example user interface 900 providing a patient data record reconciliation view, as used in one embodiment. The user interface 900 provides the user with options to reconcile data downloaded from the CDR to the client computing system 110 (e.g., to a local EHR database). Reconciliation may include options to review new and/or updated data as compared to data stored in a local EHR database or repository (e.g., on the client computing system 110) and take actions to resolve any differences (such as to keep a local copy, apply updates from a downloaded copy to the local copy, merge updates, etc.).

### Example Process for Providing a Notification Summary

FIG. 10 is a flowchart illustrating one embodiment of a process 1000 for providing a notification summary of new and/or updated patient information since a date of last access or date of inception, as used in one embodiment of the system. In some implementations, the process 1000 is performed by embodiments of the system 100 described with reference to FIG. 11. For ease of explanation, the following describes the services as performed by the system 100. The example scenarios are intended to illustrate, but not to limit, various aspects of the system 100. In one embodiment, the processes can be dynamic, with some procedures omitted and others added. For ease of explanation, certain portions of the description below describe the process with respect to a single electronic health record. However, the process may also be applied similarly to a plurality of electronic health records separately and/or in parallel, such as in batch processing of multiple thousands or millions of records.

At block 1005, a user requests patient health data (for example, an EHR, as referenced throughout the following description of the process 1000) for a patient. The user request may be received for example in response to user selection of the patient via the patient lookup and search results provided by the EHR application (e.g., as illustrated in user interface 300).

At block 1010, the EHR Application determines a time of last access of the patient EHR data at the CDR by the requesting user (or a time of inception or creation of the patient EHR, if it has not yet been accessed). The time of last access and/or the time of inception may be stored and maintained by the EHR application for each registered user of the system. In some embodiments, times may be stored and maintained for each patient. When a patient's EHR data at the CDR is accessed, the time of last access may be updated or recorded, such that on subsequent requests to access and view the patient EHR, the CDR may use this information to determine which items in the patient EHR may be new or updated since the last access.

At block 1015, once a time has been determined, the EHR may generate a service call to the CDR. The service call may comprise the time of last access (or time of inception) and an identifier of the patient. The service call may further comprise authentication information for the EHR user (e.g., username, password, authentication token, and/or the like) or a practice identifier. In some embodiments, the service call is a web service call.

In some embodiments, the time of last access may be updated or recorded to provide the user with the most current view of new or updated items, such as the case may be if the user accesses the patient EHR more than one time in a given day. For example, a physician might access and view a patient's EHR in the morning in preparation for an appointment later in the day; sometime after the morning access, but before the patient's appointment, the patient's EHR data at the CDR may be updated (for example, perhaps a lab test result is received and processed by the CDR). Later when the physician accesses the patient's EHR again (e.g., shortly before or during the appointment), the EHR application may trigger a second web service call to CDR with an updated time of last access, and she may then be presented with a notification summary that the lab test results are now available. This may be particularly beneficial as the physician may already be familiar with the rest of the patient's EHR after the first access, and thus the new information may be of more immediate interest during the subsequent access.

At block 1020, the CDR, upon receiving the service call from the EHR application, determines whether any items associated with the patient EHR are new and/or have been updated since the time of last access or time of inception. For example, the CDR may store in each item of a patient's EHR information indicative of times on which respective items were added or updated. This data may then be used, for example, to compare the time of last access to the respective dates of those items to determine which items may have been added (new items) or updated since the last access. In some embodiments, data or data updates that originated from the EHR application associated with the user are excluded (e.g., using a practice identifier included in the service call), such that the user will only be notified of data or data updates originating from other sources (e.g., third-party sources, such as other health record data sources 172).

At block 1025, the CDR server generates a notification summary of the new and/or updated items since the last access, to be displayed to the user by the EHR application. The notification summary may include a list of particular items, or a list of items by category, such that the clinical user can quickly review and see at a glance whether any items are new or updated and if so, at least some information describing those items. Thus the clinical user can use this information to quickly or more efficiently ascertain whether a particular diagnosis or treatment may need to be revisited or updated based on any new or updated patient information that has become available in the CDR. In one embodiment, the notification summary may comprise a simple numeric indicator of how many items may be new or updated (e.g., as illustrated by the “Share” button in FIG. 4). In some instances the notification summary may comprise a summary list of items by category with respective indicators of how many items in each category may be new or updated (e.g., as illustrated in the notification summary in FIGS. 1 and 5). In some embodiments, the CDR may provide a URL to the EHR application, allowing the user of the EHR application to access and view the data associated with the notification summary.

At block 1030, the EHR application receives and provides the notification summary to the clinical user. For example, in certain embodiments the notification summary may be provided via one of the user interfaces described above. In other embodiments, the notification summary may be provided via electronic mail, text message, or other communication means. For example, in one embodiment, certain types of patient information may be flagged as more critical, such that new or updated critical information may trigger the EHR system 100 to provide a notification summary of the relevant critical information as soon as it is processed, such as via an email or text message to the patient's primary physician or caregiver.

At block 1035, a request may be received from the user to view the data associated with the notification summary. For example, the user may click on a “Share” button (as illustrated in FIG. 1 and FIG. 5) or other interface element. In some embodiments, a request is sent to the CDR for access to the data associated with the notification summary. The request may comprise a patient identifier, a practice identifier, and/or a user identifier. In response, the CDR may return to the EHR application a URL granting access to the patient's EHR data. The URL can be a secure URL containing a token to control a length of time the access is granted. In some embodiments, an embedded browser may be displayed in the EHR application showing the data at the CDR. The displayed data may be searched or filtered by one or more attributes (e.g., source of data, date the data was created or updated, and/or the like). In some embodiments, the user may select at least a portion of the displayed data to be downloaded (e.g., to a data store associated with a EHR server or a client computing system).

Once the user has viewed the new or updated data, the share notification can be removed from the EHR application interface. In addition, the time of last access can be updated to a current time.

### Example System Implementation and Architecture

FIG. 11 is a block diagram of one embodiment of an EHR system 100 in communication with a network 160 and various systems, such as client computing systems(s) 110, EHR server 120, clinical data repository server 162, and/or other health record data source(s) 172. The system 100 may be used to implement systems and methods described herein, including but not limited to the process 1000 of FIG. 10, and to provide various user interfaces described herein, including but not limited to the user interfaces of FIGS. 1-9.

### Client Computing System

The client computing system 110 includes, for example, a workstation, personal computer, or other computing device. The client computing system 110 may also correspond to a mobile device such as a laptop, tablet, or smartphone. In one embodiment, the client computing system 110 includes one or more central processing units (“CPU”) 1112, which may each include a conventional or proprietary microprocessor. The client computing system 110 further includes one or more memories 118, such as random access memory (“RAM”) for temporary storage of information, one or more read only memories (“ROM”) for permanent storage of information, and one or more mass storage devices (not shown), such as a hard drive, diskette, solid state drive, or optical media storage device. Typically, the modules of the client computing system 110 are connected to the computer using a standard based bus system. In different embodiments, the standard based bus system could be implemented in Peripheral Component Interconnect (“PCI”), Microchannel, Small Computer System Interface (“SCSI”), Industrial Standard Architecture (“ISA”) and Extended ISA (“EISA”) architectures, for example. In addition, the functionality provided for in the components and modules of client computing system 110 may be combined into fewer components and modules or further separated into additional components and modules.

The client computing system 110 is generally controlled and coordinated by operating system software, such as Windows XP, Windows Vista, Windows 7, Windows 8, Windows Server, Unix, Linux, SunOS, Solaris, iOS, Blackberry OS, or other compatible operating systems. In Macintosh systems, the operating system may be any available operating system, such as MAC OS X. In other embodiments, the client computing system 110 may be controlled by a proprietary operating system. Conventional operating systems control and schedule computer processes for execution, perform memory management, provide file system, networking, input/output (“I/O”) services, and provide a user interface, such as a graphical user interface (“GUI”), among other things.

The client computing system 110 may include one or more commonly available I/O devices and interfaces 116, such as a keyboard, mouse, touchpad, and printer. In one embodiment, the I/O devices and interfaces 116 include one or more display devices, such as a monitor, that allows the visual presentation of data to a user. More particularly, a display device provides for the presentation of GUIs, application software data, and multimedia analytics, for example. The client computing system 110 may also include one or more multimedia devices 1114, such as speakers, video cards, graphics accelerators, and microphones, for example.

### EHR Application Server

In the embodiment of FIG. 11, a user using a client computing system 110 accesses an EHR application 122. In some embodiments, EHR application 122 is stored on an application server (e.g., EHR server 120). EHR server 120 may be coupled to client computing system 110 through a network (not shown). For example, a single healthcare entity, such as a hospital, may have a plurality of client computing systems 110 all configured to access a single EHR server 120 containing EHR application 122. In other embodiments, EHR application 122 may be installed on individual client computing systems 110.

The EHR application 122 includes an EHR management module 124, and a user interface module 126. The EHR management module 124 and user interface module 126 may be stored in an EHR data store 128 as executable software codes that are executed by a CPU associated with the EHR server 120 and/or client computing system 110 (e.g., CPU 112 of client computing system 110). These and other modules in the EHR application 122 may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. In the embodiment shown in FIG. 11, the EHR application 122 is configured to execute the modules recited above to perform the various methods and/or processes for providing a notification summary of new and/or updated patient information since a time of last access or time of inception as described herein (such as the process 1000 described with respect to FIG. 10 herein) in conjunction with CDR server 162.

The user interface module 124 provides capabilities related to generating and/or providing one or more user interfaces of patient information views and features described herein. The user interface module 124 may be configured to, for example, generate one or more user interfaces, such as the user interfaces shown in FIGS. 1-9, to provide the features described herein. In one embodiment, some or all of the user interfaces and/or UI elements may be generated either by the EHR application 100 and provided to the client computing system 168, or they may be generated on the client computing system 168 via a local user interface module, or in some combination thereof.

The EHR management module 124 provides capabilities related to management of patient EHRs by the EHR application 122, for example as stored in the EHR data store 128. For example, the EHR management module 124 may be configured to perform patient identity matching which may include providing and/or maintaining a unique identifier and standard way to search, retrieve, and manage data. The patient identifier may enable users (e.g., users of client computing system 110) to find, exchange, and reference entity data while maintaining the entity data's own context and associations.

The EHR management module 124 may also be configured to request access patient EHR data from CDR server 162, in order to determine whether and which items may be new or updated since a last access date, and provide a notification summary of new and/or updated patient information.

The client computing systems 110 and EHR server 120 implementing EHR application 122 may collectively form a health record data source 170.

### CDR Application Server

CDR server 162 is configured to manage and maintain a CDR data store 168 comprising data from a plurality of different health record data stores. CDR server 162 may receive data and requests from a plurality of different health record data sources 170 and 172. For example, a user at a client computing system 110 may access an EHR application 122 to create patient EHR information sent to CDR server 162 to be stored in a CDR data store 168. In addition, EHR information for the patient may be retrieved by CDR server 162 from CDR data store 168 to be sent to the user for viewing or downloading.

The CDR management module 164 provides capabilities related to management of patient EHRs received from health record data sources 170 and 172 stored in the CDR data store 168. For example, the CDR management module 164 may be configured to perform patient identity matching which may include providing and/or maintaining a unique identifier and standard way to search, retrieve, and manage data from third-party systems and/or data sources. The patient identifier may enable healthcare applications and healthcare enterprises to find, exchange, and reference entity data while maintaining the entity data's own context and associations.

The CDR management module 164 may also be configured to manage and/or enforce security policies and authorizations to ensure that patient information that has been marked or flagged as secure or private may not be shared across all participating third party entities. For example, one healthcare provider may designate some patient information as secure or private, and in response the secure or private patient information may not be made available to other participating healthcare providers (including, for example, the exclusion of any secure or private patient information from notification summaries even if the secure or private patient information is new or updated).

The data integration engine 166 provides capabilities related to integration and reconciliation of data from multiple data sources. For example, the data integration engine 166 may be configured to support a variety of data types and transports that can be received by the CDR server 162. The data integration engine 166 may also be configured to perform processes related to merging of patient information with an existing patient data record in the CDR data store 168 and/or creation of new patient data record for storage in the CDR data store 168.

### Network

In the embodiment of FIG. 11, the I/O devices and interfaces 116 provide a communication interface to various external devices. In the embodiment of FIG. 11, the EHR server 120 is electronically coupled to a network 160, which comprises one or more of a LAN, WAN, and/or the Internet, for example, via a wired, wireless, or combination of wired and wireless, communication link. The network 160 communicates with various computing devices and/or other electronic devices via wired or wireless communication links.

According to FIG. 11, in some embodiments information may be provided to or accessed by the EHR server 120 over the network 160 from the CDR server 162 and/or other health record data source(s) 172. The CDR server 162 and/or other health record data source(s) 172 may include one or more internal and/or external data sources. In some embodiments, one or more of the databases or data sources may be implemented using a relational database, such as Sybase, Oracle, CodeBase, MySQL, and Microsoft® SQL Server as well as other types of databases such as, for example, a flat file database, an entity-relationship database, and object-oriented database, and/or a record-based database.

### Data Sources

The CDR data store 168 may store, for example clinical data associated with patients of a healthcare provider or organization. The types of clinical data that can be stored in the CDR data store 168 may include, for example, full patient demographics and clinical observations, such as a patient's medical history, diagnoses, medications, treatment plans, immunization dates, allergies, radiology images, and laboratory and test results. The clinical data may be stored as EHRs for respective patients, or in any other data format which may be appropriate, and may include clinical data provided by, accessed from, retrieved from, and/or processed or translated from EHR server 120 and third-party systems and/or health record data sources 172, such as other healthcare providers and organizations (e.g., labs, pharmacies, and/or the like).

The health record data sources 172 may store, for example clinical data associated with patients of other healthcare providers or organizations. The types of clinical data that can be stored in the health record data sources 172 may include, for example, full patient demographics and clinical observations, such as a patient's medical history, diagnoses, medications, treatment plans, immunization dates, allergies, radiology images, and laboratory and test results. The clinical data may be stored as EHRs for respective patients, or in any other data format which may be appropriate.

### Other Embodiments

Each of the processes, methods, and algorithms described in the preceding sections may be embodied in, and fully or partially automated by, code modules executed by one or more computer systems or computer processors comprising computer hardware. The code modules may be stored on any type of non-transitory computer-readable medium or computer storage device, such as hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, or any other tangible medium. Such software code may be stored, partially or fully, on a memory device of the executing computing device, such as the EHR system 100, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “for example,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

While certain example embodiments have been described, these embodiments have been presented by way of example only, and are not intended to limit the scope of the disclosure. Thus, nothing in the foregoing description is intended to imply that any particular element, feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

All of the methods and processes described above may be embodied in, and partially or fully automated via, software code modules executed by one or more general purpose computers. For example, the methods described herein may be performed by the EHR system 100 and/or any other suitable computing device. The methods may be executed on the computing devices in response to execution of software instructions or other executable code read from a tangible computer readable medium. A tangible computer readable medium is a data storage device that can store data that is readable by a computer system. Examples of computer readable mediums include read-only memory, random-access memory, other volatile or non-volatile memory devices, CD-ROMs, magnetic tape, flash drives, and optical data storage devices.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A system for providing access to patient electronic health record (EHR) data items, comprising:
a computing system comprising at least one computing device having a processor, the computing system including at least:
an electronic health record module in electronic communication with an electronic data store configured to at least store clinical data including health records associated with a plurality of patients, wherein the electronic health record module is programmed via executable instructions that cause the computing system to at least:
receive from a user a selection specifying a patient of the plurality of patients;
determine a time of interest associated with the health record, wherein the time of interest is associated with the user;
access, from the electronic data store, a health record associated with the patient, wherein accessing the electronic data store comprises:
transmitting a request to the electronic data store, the request comprising at least a patient identifier corresponding to the patient, the time of interest, and authorization information associated with the user;
receiving, from the electronic data store, a notification summary, wherein the notification summary specifies whether any items associated with the health record are new or have been updated since the time of interest, excluding any items associated with the electronic health record module; and
providing the notification summary to the user.

2. The system of claim 1, wherein the time of interest is the time of last access of the health record, wherein the time of last access is the time at which the user requesting access to the health record last accessed the health record.

3. The system of claim 1, wherein the time of interest is the time of inception of the health record, wherein the time of inception is the time at which the health record was added to the electronic data store.

4. The system of claim 3, wherein the user requesting access to the health record has not yet accessed the health record.

5. The system of claim 1, wherein the items associated with the health record include at least one of a medical history for the patient, one or more diagnoses, one or more medications, one or more treatment plans, one or more immunization dates, one or more allergies, one or more radiology images, and one or more laboratory test results.

6. The system of claim 1, wherein the notification summary is provided in a user interface presented in a web application, a mobile application, or a stand-alone application.

7. The system of claim 1, wherein the electronic health record module is further programmed via executable instructions to update the time of interest associated with the user to a current time.

8. The system of claim 1, wherein the health record comprises patient demographics and clinical observations associated with the patient.

9. The system of claim 1, wherein the health record comprises information associated with the patient sourced from one or more participating healthcare provider entities.

10. The system of claim 1, wherein the health record comprises security information associated with at least one item contained in the health record, wherein the security information indicates whether a participating healthcare provider is allowed to view the at least one item.

11. The system of claim 1, wherein the notification summary comprises a numeric indicator of how many items contained in the health record are new or have been updated since the time of interest.

12. The system of claim 1, wherein the notification summary comprises a popover user interface panel which presents a list of one or more types of items which have new or updated items contained in the health record and respective numeric indicators for each of the one or more types of items to indicate how many items of the respective type are new or have been updated since the date of interest.

13. The system of claim 1, wherein the notification summary provides an option for the user to download the new or updated items contained in the health record to a local health data repository.

14. A computer-implemented method for accessing patient electronic health record (EHR) data items, comprising:
as implemented by an electronic health record module associated with one or more computing devices configured with specific executable instructions,
receiving, from a user, a selection specifying a patient of the plurality of patients;
determining a time of interest associated with the health record, wherein the time of interest is associated with the user;
accessing, from the electronic data store, a health record associated with the patient, comprising:
transmitting a request to the electronic data store, the request comprising at least a patient identifier corresponding to the patient, the time of interest, and authorization information associated with the user;
receiving, from the electronic data store, a notification summary, wherein the notification summary specifies whether any items associated with the health record are new or have been updated since the time of interest excluding any items associated with the electronic health record module; and
providing the notification summary to the user.

15. The computer-implemented method of claim 14, wherein the time of interest is the time of last access of the health record, wherein the time of last access is the time at which the user requesting access to the health record last accessed the health record.

16. A system for accessing patient electronic health record (EHR) data items, comprising:
a computing system comprising at least one computing device having a processor, wherein the computing system including at least:
an clinical data repository module in electronic communication with an electronic data store configured to at least store clinical data including health records associated with a plurality of patients, wherein the clinical data repository module is programmed via executable instructions to at least:
receive, from a user at a first client system, a request for electronic health information associated with a patient, wherein the request specifies at least a patient identifier corresponding to the patient, a time of interest, and authorization information associated with the user;
accessing a health record associated with the patient based at least in part upon the patient identifier, wherein the health record is associated a plurality of items received from a plurality of different client systems;
constructing a notification summary, wherein the notification summary specifies whether any items associated with the health record are new or have been updated since the time of interest, excluding any items received from the first client system,
returning the notification summary to the first client system.

17. The system of claim 16, wherein to determine whether any items associated with the health record are new or have been updated since the time of interest, the clinical data repository module is further programmed via executable instructions to:
determine, for respective items associated with the requested health record, respective times on which the respective items were added to the electronic data store or updated in the electronic data store; and
compare the respective times to the time of interest to determine which respective items were added to the electronic data store or updated in the electronic data store after the time of interest.

18. A system, comprising:
a computing system comprising at least one computing device having a processor, the computing system in communication with
an electronic data store configured to at least store clinical data including health records associated with a plurality of patients,
said computing system including at least:
an electronic health record module programmed via executable instructions to at least:
access, from the electronic data store, a health record associated with a patient;
determine a time of interest associated with the health record, wherein the time of interest is associated with a particular user;
determine whether any items associated with the health record are new or have been updated since the time of interest;
generate a notification summary comprising at least the new and/or updated items; and
provide the notification summary.

19. The system of claim 18, wherein to determine whether any items associated with the health record are new or have been updated since the date of interest, the electronic health record module is further programmed via executable instructions to:
determine, for respective items associated with the health record, respective times on which the respective items were added to the electronic data store or updated in the electronic data store; and
compare the respective times to the time of interest to determine which respective items were added to the electronic data store or updated in the electronic data store after the time of interest.

20. The system of claim 18, wherein the time of interest is the time of last access of the health record, wherein the time of last access is the time on which the particular user requesting access to the health record last accessed the health record.
